(19) United States
(12) Patent Application Publication
(10) Pub. No.: US 2002/0133718 A1
(43) Pub. Date: Sep. 19, 2002

(54) Private enterprise network incorporating digital subscriber lines

(76) Inventor: Bryan L. Turbow, Dove Canyon, CA (US)

Correspondence Address: Bryan L. Turbow, Myrient, Inc., 65 Enterprise, Aliso Viejo, CA, 92656-2601, US

(21) Appl. No.: 09/809,151

(22) Filed: Mar. 15, 2001

(51) Int. Cl. G06F 11/30

(52) U.S. Cl. 713/201

(57) ABSTRACT

A private enterprise network system for secure nonencrypted data transmission between computers of an entity but not over the Internet or other public, global computer network. At least one of the computers is connected to a shared, private backbone via an xDSL system. The private enterprise network is adapted to provide secure data transmission to multiple entities over the shared, private backbone. Further, the addresses of the computers in the entity may be of any suitable IP space, and different entities may have addresses in the same IP space. The addresses of the data transmitted are translated by a translation system that changes the entity addresses to private addresses for routing through a switch and router array system that has entity dedicated channels based on the private addresses. After exiting the switch and router array system, the data moves through the translator again and the private address is translated back to the entity address and the data is transmitted to the desired computer.

### BACKGROUND OF THE INVENTION

1. Field of the Invention

This invention relates to broad band access to global communications systems and, more specifically, to secure private networks.

2. Description of the Related Art

In today's business world, being able to network in any sense of the word is of paramount importance. With the explosion of the Internet and emerging access broadband technologies, data networking in particular has become almost imperative to the operations of all companies. Whether it is business-to-business communications, satellite office to headquarters, or e-commerce, being able to network means being able to do business in the 21^{st} century.

Traditionally, only the large companies, with budgets to match, could take part in data networking. Wide area networks, frame relay and leased lines became standard and due to the limited number of carriers, it was, and still is, a fairly expensive process. It also has the advantage of a high level of security in transmitting data.

Businesses, and individuals, who do not have the resources to install or lease hardwired communications lines are concerned with the lack of security and privacy in using the Internet. Additionally, organizations today are faced with the growing requirements of managing complicated networks with increasing numbers of users, the demands of enterprise and Internet-based applications, and providing secure access to many types of users.

The recent emergence of lower cost and readily accessible broad band technologies has made it possible to include all types and sizes of businesses at much more reasonable costs. However, the prior art broad band technologies as come with increased concerns for security and economic efficiency.

Technologies are present to meet this need for private communications, including many variations of encryption. A Virtual Private Network (VPN) is one encryption solution to providing privacy to Internet communications. Referring now to FIG. 1, VPN 10 is an Internet-based encrypted tunnel 12 between two connected points, such as computer A 14 and computer B 16. The VPN client software 18 of computer A 14 takes the data 20 to be transmitted and produces encrypted data 22 which is transmitted to an Internet gateway 24. The encrypted data 22 is then sent to the public Internet 26 where the data 22 then makes many hops through many carriers 28. The now Internet transmitted encrypted data 30 is directed through another gateway 32 and to the computer B 16. The VPN software 34 for the computer B unencrypts the data 30 to produce data 36 for computer B.

However, VPN has limitations. VPN is married to the publically-accessed Internet with all of its traffic and congestion and inherent slowdowns. VPN is also dependent on data encryption software on both ends to maintain security, which adds significant overhead on the networking devices as well as impacting the efficiency of the connection itself. Further, the much slower dial-up connections just do not work well in a VPN scenario. Additionally, special VPN software is needed at an additional cost. Also, VPN is not suitable for data that cannot be encrypted, such as data comprising xrays or other medical scans.

What is needed is a cost-effective, secure and economic broad-band access solution at a reasonable cost that can effectively accommodate many users.

### SUMMARY OF THE INVENTION

A novel and unique private enterprise network (PEN) has been discovered that economically and flexibly provides secure data transmission between many types of users at many locations. PEN meshes one or more national networks together through the facilities of multiple carriers that results in a resilient, integrated platform which does not engage with the public Internet. Further, PEN does not require the encryption or other special software, which is costly to purchase and maintain.

PEN utilizes a private backbone to which are users are connected via digital subscriber lines (DSL). Thereby, PEN enables all data traffic to move through a private and secure network and not across congested and non-secure Internet access points. This results in accelerated delivery through PEN such as e-mail, file transfers, and other internal traffic.

Additionally, aspects of PEN include providing secure data transmission between two separate users or between a plurality of users. Further, aspects of PEN are easily converted to accommodate more or less users, creating an extremely flexible network.

In an aspect of PEN, the network architecture is based on building an efficient data network ‘on top’ of major metropolitan fiber optic interconnected points within class ‘A’ carriers. Another aspect of PEN has centers that connect to the Internet through multiple, diverse, ultra-fast OC-x circuits that move gigabits of data per second.

In aspects of PEN, access to data is controlled. For example, in an aspect of PEN, specific users are enabled to or prohibited from accessing particular data available within PEN just as with a private wide area network. In another aspect, users have restricted access or are prohibited access to the Internet through a mediated, proxy access.

In another aspect of the invention, PEN provides the benefits of private network systems without the burden of network management, investment in Internet access, expensive hardware, and obsolete equipment through management by a PEN provider.

In an aspect of the invention, a private enterprise network system for secure, nonencrypted data transmission between a first computer and a second computer of an entity comprises first and second user equipment, a shared, private backbone, a translator system, a switch and router system, and an xDSL system. The first user equipment is connected to the first computer, the first user equipment being adapted to receive data transmission from the first computer and to add an entity address to the data transmission that identifies the second computer. The second user equipment is connected to the second computer, the second user equipment being adapted to receive data transmission with the entity address and direct the data transmission to the second computer. The shared, private backbone is in functional communication with the first user equipment and the second user equipment and adapted to be in functional communication with another entity's user equipment. The translator system is in functional communication with the private backbone and being adapted to receive the data transmission with the entity address via the shared, private backbone and translate the entity address into a private address. The switch and router array system comprises a plurality of entity dedicated channels, being in functional communication with the translator system, and is adapted to receive the private address data transmission from the translator, direct the private address data transmission through an appropriate entity dedicated channel based on the private address, and return the private address data transmission to the translator system, wherein the translator system translates the private address of the data transmission into the entity address and directs the data transmission to the shared, private backbone for transmission to the second user equipment. The xDSL system is between the first user equipment and the shared, private backbone or the second user equipment and the shared, private backbone.

In a further aspect of the invention, the first and second user equipment comprises a router, bridge, or modem

In a further aspect of the invention, the switch and router array system comprises a universal access concentrator.

In a further aspect of the invention, the switch and router array system is enabled to handle media translation, security policies, circuit aggregation, or Intranet routing.

In a further aspect of the invention, the translator system and the switch and router system is combined into a single system.

In a further aspect of the invention, both first and second user equipment is connected to the shared, private backbone by xDSL systems.

In a further aspect of the invention, the entity has a plurality of computers and user equipment.

In a further aspect of the invention, the switch and router array system is enabled to restrict transmission of all data between the first computer and the second computer or previously identified data between the first and second computer.

In a further aspect of the invention, a core asynchronous transfer mode switch is between the shared, private backbone and the translator system.

In a further aspect of the invention, a network address translation and proxy system is in functional communication with the shared, private backbone and with a public global computer system. In a still further aspect of the invention, the switch and router array system is enabled to restrict transmission of all data from the public global computer network or restricted data requested by a user of the first computer from the public global computer network.

In a further aspect of the invention, another entity is in functional with the shared, private backbone.

In an aspect of the invention, a private enterprise network system installation process comprising the steps of:

identifying a first computer and second computer of an entity desired to be connected such that secure, nonencrypted transmission of data occurs between a first computer and a second computer;

connecting first and second user equipment to the first and second computers, respectively, the first user equipment being adaptable to receive data transmission from the first computer and to add an entity address to the data transmission that identifies the second computer, and the second user equipment connected to the second computer, the second user equipment being adaptable to receive data transmission with the entity address and direct the data transmission to the second computer;

connecting the first and second user equipment to a shared, private backbone that is capable of being in functional communication with another entity's user equipment and is not publically accessible, wherein at least one of the first and second user equipment is connected to the shared, private backbone via an xDSL system;

connecting a translator system to the private backbone, the translator system being adaptable to receive the data transmission with the entity address via the shared, private backbone and translate the entity address into a private address; and

connecting a switch and router array system comprising a plurality of entity dedicated channels to the translator system, wherein the switch and router system is adaptable to receive the private address data transmission from the translator, direct the private address data transmission through an appropriate entity dedicated channel based on the private address, and return the private address data transmission to the translator system, wherein the translator system translates the private address of the data transmission into the entity address and directs the data transmission to the shared, private backbone for transmission to the second user equipment.

In an aspect of the invention, the number of the computers of the entity connected to the backbone changes.

### BRIEF DESCRIPTION OF THE DRAWINGS

FIG. 1 is a schematic view of a virtual private network known in the prior art.

FIG. 2 is a schematic view of a private enterprise network according to an embodiment of the invention.

FIG. 3 is a schematic view of a three tiered model of a private enterprise network according to an embodiment of the invention.

FIG. 4 is a schematic view of a private enterprise network according to an embodiment of the invention.

FIG. 5 is a schematic view of a hybrid private enterprise network according to an embodiment of the invention.

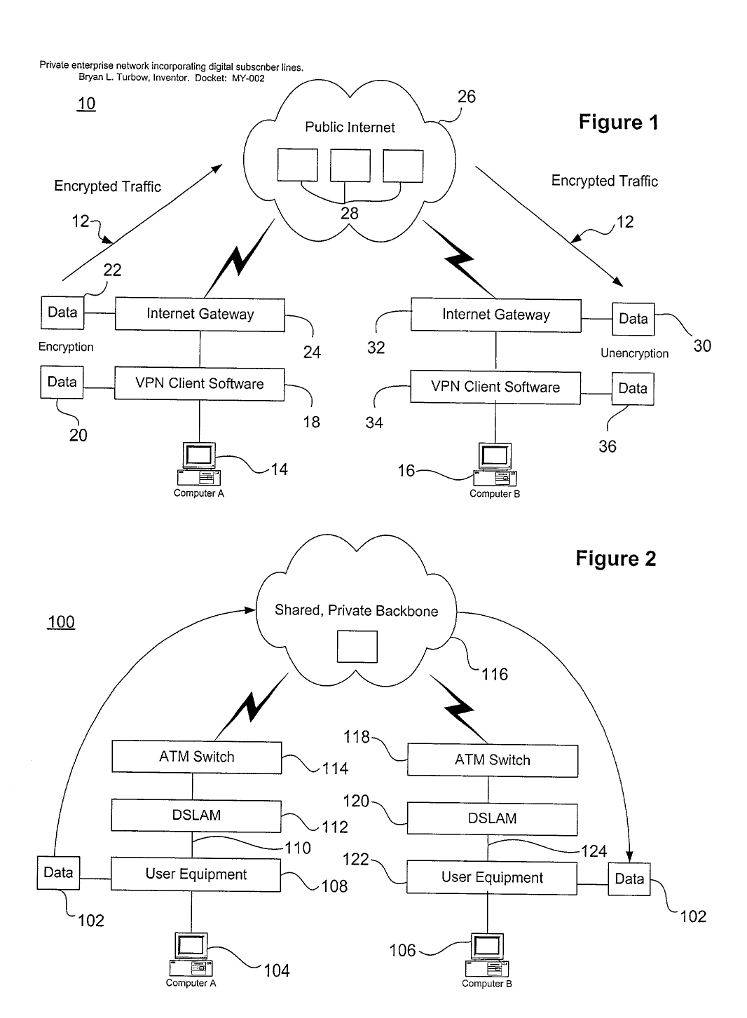

### DESCRIPTION OF THE PREFERRED EMBODIMENTS

Referring now to the figures, wherein like reference numerals refer to like elements throughout the figures, and referring specifically to FIG. 2, in an embodiment of the invention, a private enterprise network (PEN) 100 transmits data 102 between a computer A 104 and a computer B 106 of an entity. The data 102 is transmitted securely and it is not transmitted over the publically accessible Internet. As a result, there is no need for encryption software in the computers A 104 and B 106 as is required with the virtual private network of the prior art. An entity is something that exists as a particular and discrete unit, such as a corporation, partnership, individual, or organization, for a non-inclusive list of examples.

More specifically, the data 102 is directed from computer A 104 to user equipment 108. In embodiments of the invention, the user equipment 108 is a router, bridge, or modem. The user equipment 108 directs the transmitted data 102 through an xDSL connection 110 to a DSLAM 112. The data 102 is then directed to an asynchronous transfer mode (ATM) switch 114. Next, the data 102 is directed into a shared, private backbone 116 through, preferentially, a single carrier. The data 102 is then transmitted through an ATM switch 118 and a DSLAM 120 associated with computer B 106. Next the data 102 is directed through another xDSL connection 124 to a user equipment 122 and into computer 106.

The shared, private backbone 116 is any data transmission conduit that does not include the Internet or any other public global computer network. The shared, private backbone 116 is comprised of two or more private channels, each of which enables secure, private data transmission there through for a plurality of entities. Each entity desires secure, private data transmission without encryption of the data and without requiring it's own, individual private backbone. The shared, private backbone may be owned or leased by a backbone administrator. Further, the shared, private backbone may be a combination of owned/leased data transmission conduits that combined create a PEN that extends geographically to all of the computers of the entity. In an embodiment of the invention, the private backbone architecture is comprised of ATM private line circuits in a mixed copper and fiber environment. Other embodiments of the invention comprise other suitable data transmission environments.

It is to be understood that xDSL means any appropriate DSL communication configuration. DSL, or Digital Subscriber Line, is one of the technologies used to achieve broadband speeds over ordinary telephone lines. More specifically, DSL is a telecommunications service that enables a copper phone line loop to transmit data without having to dial into the telephone line. In some forms of DSL, voice and data traffic are on the same copper phone line loop.

Embodiments of the invention are not limited to currently available forms of DSL nor are the embodiments limited to currently available xDSL transmission speeds. xDSL connections include, but are not limited to:

1. IDSL (ISDN DSL) which uses ISDN provisioning and testing, and can exist with analog and ISDN services. IDSL is limited to 144 kbps upstream (to the user) and downstream (from the user), but can sometimes provide further reach than other DSL solutions because it does not have the same distance limitations.

2. ADSL (Asymmetric DSL) which uses two different transmission speeds, with the downstream speed usually being much higher than the upstream speed. ADSL can achieve downstream speeds of 8 Mbps and upstream speeds to 1 Mbps.

3. VDSL (Very High Speed DSL) which is anticipated to provided higher speeds than ADSL but requires a shorter transmission distance between the User equipment and the DSLAM.

4. RADSL (Rate Adaptive DSL) which modifies the data transmission rate to match the quality of the phone line. Low quality phone lines introduce ‘noise’ into the data transmission, which slows it down. Currently, with conditioned phone lines, RADSL provides downstream transmission rates of 7 Mbps downstream and 1 Mbps upstream.

5. HDSL/SDSI (High Data Rate DSL/Symmetric DSL) which uses two standard phone lines for 1.5 Mbps transmission speeds and offers the capability to combine three phone lines for 2 Mbps speeds. HDSL and SDSL are intended as lower cost replacements for dedicated and fractional T-1 lines.

xDSL connections provide a positive economic combination of cost and performance for a wide range of applications. xDSL does not require hardware and transmission line upgrades as it typically uses the available phone lines, providing the quality of the copper phone lines enables desired transmission speeds.

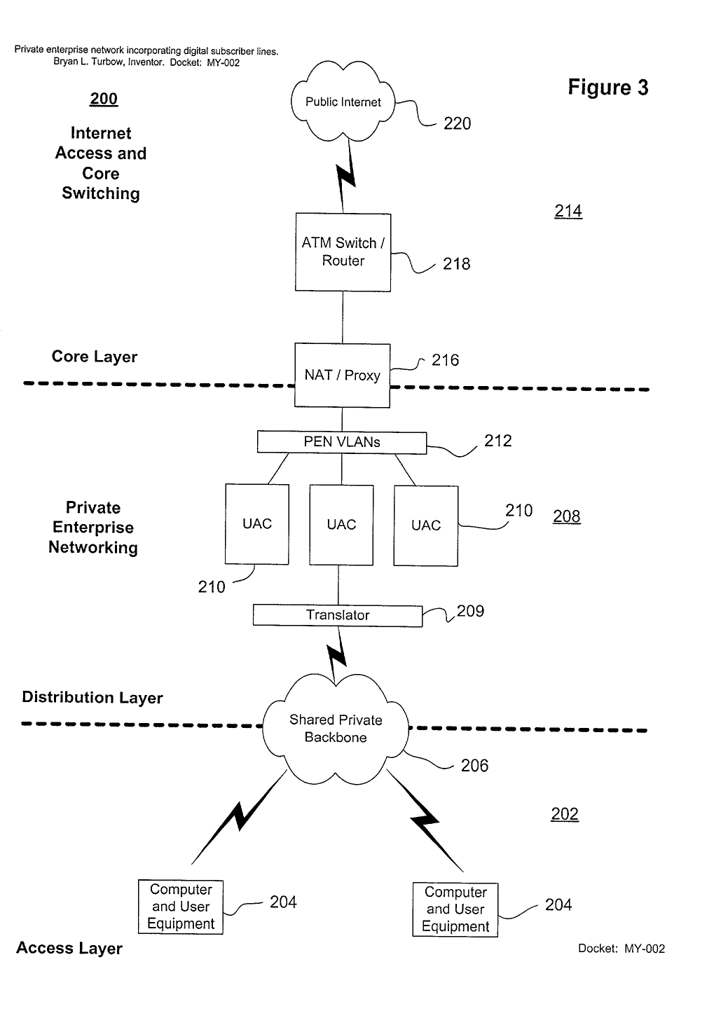

Referring now to FIG. 3, an embodiment of the invention, the PEN utilizes a three-tiered model 200. The first tier, or the access layer 202, comprises a plurality of computers and user equipment which is connected to a larger, private shared network 206, which comprises the shared, private backbone discussed above in connection with FIG. 2. The plurality of computers and user equipment is associated with a single entity as shown.

Embodiments of the invention have one or more entities connected to the network 206, with each entity having a plurality of computers and user equipment. Further, each entity has entity addressing for data transmission, but PEN 200 permits different entities to have computers with the same addresses and still maintain data security. The entities use the shared, private backbone for data transmission between computers but the PEN 200 is designed such that computers only transmit data between other computers of the same entity.

In an embodiment of the invention, the entity addresses are based on RFC 1918 network numbering and as such supports any appropriate IP range. In still further embodiments of the invention, PEN 200 architecture assigns CIDR IP blocks as large a /8 to customers. In another embodiment of the invention, the IP space is independent of the Internet's addressing scheme and subnets are custom designed creating private IP spaces that are not routable on the Internet, whereby security of the data transmission in the private IP spaces is enhanced. In another embodiment of the invention, the PEN 200 layers publicly routable IP ranges and maintains desired security levels.

The second tier, or the distribution lay 208, receives data from the network 206 into an translator 209 and then to a universal access concentrator (UAC) 210 or other suitable array of switches and routers.

The translator 209 translates the entity addresses into private addresses for the data coming in from the network 206 before the data enters the UAC 210. The private addresses enable the data to enter, move through, and exit the UAC 210 through an appropriate entity dedicated channel based on the private address. The data exiting the UAC 210 is directed through the translator 209 and the translator translates the private addresses back to the entity addresses so that the data can be directed through the shared, private backbone and to the desired computer.

In an embodiment of the invention, there are multiple translators that are in mutual communication such that their operations are coordinated. One or more of the translators comprise a translator system.

The UACs 210 handle media translation, security policies, circuit aggregation, and Intranet routing. In embodiments of the invention, the channels in the UAC 210 are manually and/or automatically allocated to each entity. The UAC 210 is designed such that only one entity uses a channel.

In embodiments of the invention, there are one or more UAC's, forming a UAC system or a switch and router array system. In embodiments of the invention, the individual arrays of the switch and router array system, or the individual UACs if that is the case, are connected via a VLAN system 212 or other suitable data transmission connection. In a preferred embodiment of the invention, the multiple UACs and translators are geographically dispersed about the network 206. In an embodiment of the invention, the translator system and the UAC system is combined into a single translator/UAC system.

While embodiments of the invention may use any suitable protocol in the distribution layer 208, in a preferred embodiment of the invention, the second tier protocols comprise ATM encapsulation as defined by RFC 1483, frame relay as defined by RFC 2427, and HDLC as defined by RFC 1662.

The third layer, or the core layer 214 is in connection with the distribution layer 208 through a network address translation and proxy system 216. In embodiments of the invention, the system 216 comprises one or more suitable devices. The system 216 is Connected to an ATM switch/router system 218 that enables access to the public Internet 220. In an embodiment of the invention, PEN 200 peers with network access points, such as, but not limited to, the network access point service identified as InterNAP.

In some embodiments of the invention, only the first two tiers, the access layer 202 and the distributer layer 208, are present as it is desired that data transmission between only computers in the PEN is allowed.

For embodiments of the invention with third tiers 214 and Internet access, the Internet access is designed to protect PEN from unwanted outside intrusions. Utilization of the RFC 1918 private numbering protocol prohibits Internet routing. However, Internet traffic is directed to one or more proxies that can track outbound requests, retrieve the requests for the originating machine, and pass the requests to the requesting computer in the PEN. This ensures that the Internet traffic is one way and traffic originating from the Internet is inhibited from entering the first two tiers of the PEN.

In an embodiment of the invention, PEN architecture is designed around a TCP/IP model, however other embodiments of the invention include any suitable architecture utilizing other communication protocols, of which a non-exclusive list comprises SNA and SPX/IPX. In a preferred embodiment of the invention, the other communication protocols require a bridge solution.

Still referring to FIG. 3, an example of data transmission in an embodiment of the invention follows. The user equipments 204 are configured with RFC 1918 private numbers. A data packet from one of the user computers is encapsulated within ATM cells that become aggregated at a DSLAM, which resides at a local telco central office. As the cells leave the DSLAM, they are segregated within their own permanent virtual circuit (PVC) and sent upstream over a larger pipe into the larger ATM network 206. Each PVC is separately built with the distribution layer 208 on dedicated sub-interfaces, channels, at which time private TCP/IP addressing is established. The traffic is then routed to other approved locations, in which case the packets are broken down into ATM cells and directed toward the destination PVC and to the designation DSL router. Upon arriving at the destination DSL router, the cells are reconstructed into IP packets and directed to the other computer. In other words, the transmission is entirely ATM and the distribution layer adds the IP numbering to determine desired routing. The packets do not enter the public Internet with the IP numbering remaining private.

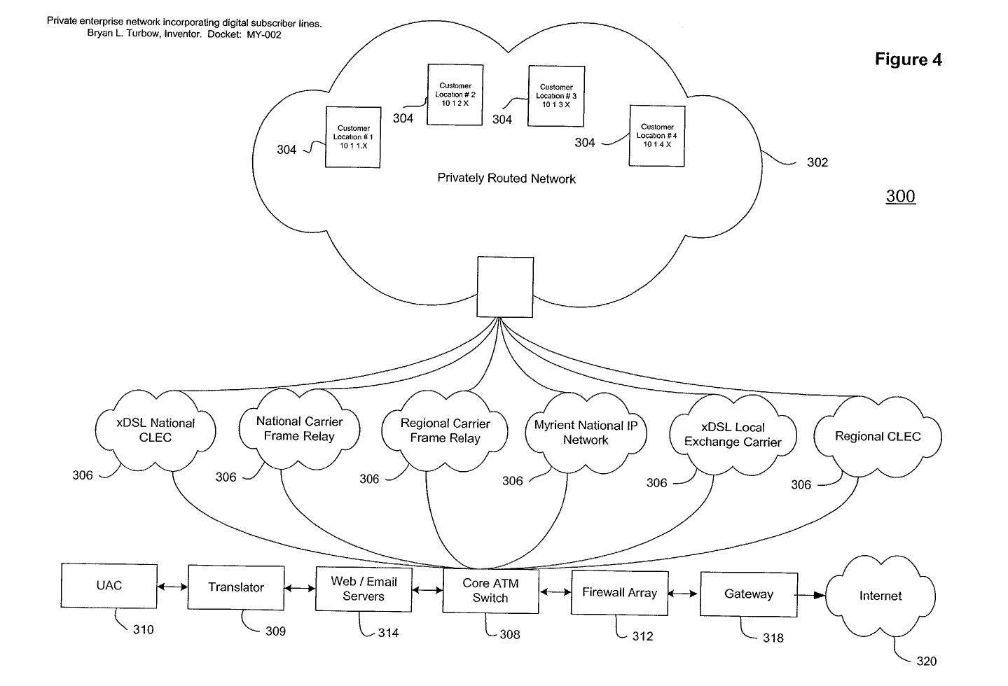

Embodiments of the invention are flexible enough to incorporate existing private networks. Referring now to FIG. 4, an embodiment of the invention comprises a PEN 300 that incorporates a privately routed network 302. It is shown that the privately routed network 302 comprises a plurality of locations 304. The PEN 300 is designed and arranged such that data is transmitted through one or more xDSL systems 306 to a core ATM switch 308. The data transmission options from and to the core ATM switch 308 include directing the data to a universal access concentrator 310 and to an Internet access system 312. The Internet access system 312 comprises a server system 314 for handling web, e-mail and DNS functions, a firewall array system 316, an integrated web and Internet proxy incorporated into a gateway 318 which permits secure access to the Internet 320. In a preferred embodiment of the invention, core ATM switch 308, the universal access concentrator system 310, and the firewall array system 316 are CISCO products.

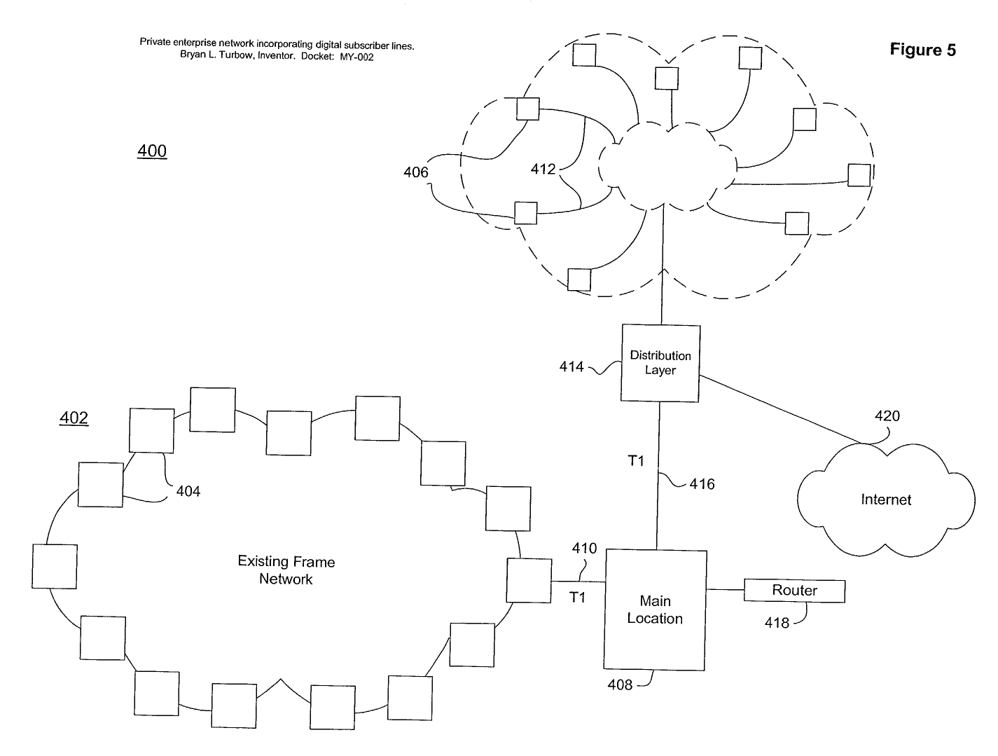

Referring now to FIG. 5, in an embodiment of the invention, a hybrid PEN 400 incorporates an existing frame network 402 connecting a first plurality of locations 404 with a second plurality of locations 406. The frame network 402 is connected to a main location 408, such a headquarters, via a T1 line 410. The second plurality of locations 406 are in functional communication via xDSL systems 412 to distribution layer 414. The distribution layer 414 is in communication with the main location 408 via another T1 line 416. A router 418 with two DSU cards is utilized to direct data traffic between the existing frame network 402 and the second plurality of locations 406. In a preferred embodiment of the invention, the router 418 is a CISCO brand system, but other suitable devices for routing data traffic are used in other embodiments.

In the shown embodiment of the invention, access to the Internet 420 is available only through the distribution layer 414 for all of the locations 404 and 406 to enhance the security of the hybrid PEN 400.

Although presently preferred embodiments of the present invention have been described in detail hereinabove, it should be clearly understood that many variations and/or modifications of the basic inventive concepts herein taught, which may appear to those skilled in the pertinent art, will still fall within the spirit and scope of the present invention, as defined in the appended claims.

1. A private enterprise network system for secure, nonencrypted data transmission between a first computer and a second computer of an entity comprising:
a first user equipment connected to the first computer, the first user equipment being adapted to receive data transmission from the first computer and to add an entity address to the data transmission that identifies the second computer;
a second user equipment connected to the second computer, the second user equipment being adapted to receive data transmission with the entity address and direct the data transmission to the second computer;
a shared, private backbone in functional communication with the first user equipment and the second user equipment and adapted to be in functional communication with another entity's user equipment;
a translator system in functional communication with the private backbone and being adapted to receive the data transmission with the entity address via the shared, private backbone and translate the entity address into a private address;
a switch and router array system comprising a plurality of entity dedicated channels, being in functional communication with the translator system, and being adapted to receive the private address data transmission from the translator, direct the private address data transmission through an appropriate entity dedicated channel based on the private address, and return the private address data transmission to the translator system, wherein the translator system translates the private address of the data transmission into the entity address and directs the data transmission to the shared, private backbone for transmission to the second user equipment; and
an xDSL system between the first user equipment and the shared, private backbone or the second user equipment and the shared, private backbone.

2. The private enterprise network system of claim 1, wherein:
the first user equipment comprises a router, bridge, or modem; and
the second user equipment comprises a router, bridge, or modem.

3. The private enterprise network system of claim 1, wherein:
the switch and router array system comprises a universal access concentrator.

4. The private enterprise network system of claim 1, wherein:
the switch and router array system is enabled to handle media translation, security policies, circuit aggregation, or Intranet routing.

5. The private enterprise network system of claim 1, wherein:
the translator system and the switch and router system is combined into a single system.

6. The private enterprise network system of claim 1, further comprising:
another xDSL system, wherein the xDSL system is between the first user equipment and the shared, private backbone and the another xDSL system is between the second user equipment and the shared, private backbone.

7. The private enterprise network system of claim 1, wherein:
the entity has a plurality of computers and user equipment.

8. The private enterprise network system of claim 1, wherein:
the switch and router array system is enabled to restrict transmission of all data between the first computer and the second computer or previously identified data between the first and second computer.

9. The private enterprise network system of claim 1, further comprising:
a core asynchronous transfer mode switch between the shared, private backbone and the translator system.

10. The private enterprise network system of claim 1, further comprising:
a network address translation and proxy system in functional communication with the shared, private backbone and with a public global computer system.

11. The private enterprise network system of claim 10, wherein:
the switch and router array system is enabled to restrict transmission of all data from the public global computer network or restricted data requested by a user of the first computer from the public global computer network.

12. The private enterprise network system of claim 11, wherein another entity is in functional with the shared, private backbone.

13. A private enterprise network system installation process comprising the steps of:
identifying a first computer and second computer of an entity desired to be connected such that secure, nonencrypted transmission of data occurs between a first computer and a second computer;
connecting first and second user equipment to the first and second computers, respectively, the first user equipment being adaptable to receive data transmission from the first computer and to add an entity address to the data transmission that identifies the second computer, and the second user equipment connected to the second computer, the second user equipment being adaptable to receive data transmission with the entity address and direct the data transmission to the second computer;
connecting the first and second user equipment to a shared, private backbone that is capable of being in functional communication with another entity's user equipment and is not publically accessible, wherein at least one of the first and second user equipment is connected to the shared, private backbone via an xDSL system;
connecting a translator system to the private backbone, the translator system being adaptable to receive the data transmission with the entity address via the shared, private backbone and translate the entity address into a private address; and
connecting a switch and router array system comprising a plurality of entity dedicated channels to the translator system, wherein the switch and router system is adaptable to receive the private address data transmission from the translator, direct the private address data transmission through an appropriate entity dedicated channel based on the private address, and return the private address data transmission to the translator system, wherein the translator system translates the private address of the data transmission into the entity address and directs the data transmission to the shared, private backbone for transmission to the second user equipment.

14. A private enterprise system modification process comprising the steps of:
providing the private enterprise network system of claim 7,
changing the number of the plurality of the computers in the private enterprise system.
